(19) United States
(12) Patent Application Publication
(10) Pub. No.: US 2011/0016046 A1
(43) Pub. Date: Jan. 20, 2011

(54) Cash-deposit Device, Method, and System

(76) Inventors: Doug Lindstrom, Portland, OR (US); Holly Rasmussen, Portland, OR (US)

Correspondence Address: PETER A. HAAS, ESQUIRE, 1929 SW 13TH AVENUE, PORTLAND, OR, 97201, US

(21) Appl. No.: 12/827,064

(22) Filed: Jun. 30, 2010

Related U.S. Application Data
(60) Provisional application No. 61/226,381, filed on Jul. 17, 2009.

(51) Int. Cl. G06Q 40/00; G06F 15/16

(52) U.S. Cl. 705/43; 709/206

(57) ABSTRACT

A system, device, and method for performing a cash transaction using a cash transaction system is disclosed. The cash transaction system comprises an automated cash receiving and storing machine and a remote database designed to communicate with the automated cash receiving and storing machine via Internet. The automated cash receiving and storing machine includes an outer housing, a computerized means, a user-interface touch screen panel, a cash-verifying means and a receipt generating means for generating the receipt of a cash transaction. The cash transaction system utilizes a software means programmed on the computerized means to enable a user to deposit cash in the automated cash receiving and storing machine and to transfer at least one portion of the cash to at least one remote account without requiring a traditional bank account.

### PRIORITY CLAIM

The present application claims benefit under 35 USC Section 119(e) of U.S. Provisional Patent Application Ser. No. 61/226,381 filed on 17 Jul. 2009: The present application is based on and claims priority from this application, the disclosure of which is expressly incorporated herein by reference.

### BACKGROUND

The present invention relates generally to system and method for performing automatic cash transactions, and more particularly, to an improved system, device and method that enables a user to perform automatic cash transactions using an automated cash receiving and storing machine without requiring a traditional bank account.

Automated teller machines (ATMs) and related bank-note deposit and dispensing machines are well-understood in the art. For example, U.S. Pat. No. 6,006,989 issued to Ademmer on 28 Dec. 1999 discloses an automatic money-receiving and dispensing machine with a recognition device and at least one store for intermediately storing received banknotes. Other examples of similar automated transaction machines include U.S. Pat. No. 6,607,081 issued to Graef on 19 Aug. 2003 and U.S. Pat. No. 6,748,101 to Jones issued on 8 Jun. 2004. A particularly well-adopted automated teller machine is described by Scarafile in U.S. Pat. No. 7,032,245 issued on 18 Apr. 2006.

A common limitation to each of these known automated cash dispensing systems is their bulk, a limited ability of accepting cash deposits, inability to enable bill paying based on real-time cash deposits, and an inability of electronic funds transfer from employer to employee (i.e. “cashing out” tips earned by employee but rendered as credit card payments to employer), for example.

Another limitation of the existing ATMs includes the location, in part necessitated by their bulk. Typically, ATMs are located outside banks. However, many cash-compensated employees work in restaurant and service industries with hours that are outside normal banking hours and, as such, use of ATM's at the early, pre-dawn hours makes such cash-compensated users vulnerable to criminals anxious to deplete the cash-compensated user of their hard-earned currency.

Finally, and most importantly, a common limitation to known machines and methods for receiving cash currency and for enabling electronic funds transfers based on those cash deposits is a requirement that the user must have a bank or credit account associated with a debit or credit card. And, further, existing methods and machines do not enable real-time determination of the cash currency deposited in the machine.

Thus, there remains a need for a compact cash-receiving and storing machine, method, and a system for depositing cash from cash-compensated workers. Such a machine and system should accurately and reliably receive authentic currency at the point of employment and should be operable at the time of greatest need, that is, immediately after the cash-compensated employee “cashes out” at the end of their work shift. Such a device and system should be easy to use and allow the cash-compensated employee to deposit currency directly into their private bank account, or direct the cash to other venders (such as a direct bill-pay to the utility company, a portion to a retirement account, or to other on-line banking systems including PayPal, for example).

Further, to reduce cost, complexity and bulk, such an improved machine need not dispense cash to users. Instead, a safe or strong-box should be included in the machine for retention of deposited cash and subsequent removal by authorized persons (i.e. not the users).

Finally, such a machine and method should enable a user to make a physical deposit of the cash currency into the machine and immediately enable use of those deposited funds through a variety of electronic funds transfers to various third parties without requiring the user to have or to establish a debit or credit account with a bank or financial institution.

### SUMMARY OF THE INVENTION

The present invention overcomes limitations and solves problems not contemplated in the prior art. Accordingly, the present invention includes a system, device, and method that enables a user, more particularly, a cash-compensated employee to safely and securely deposit cash without requiring a traditional bank account into a compact, safe, secure, and reliable machine at the time of greatest cash liquidity. Additionally, the present invention enables the user to immediately use the deposited cash to pay bills, buy items from web-based merchants and deposit to investment accounts.

The present invention is a system, device, and method for performing a cash transaction using a cash transaction system wherein the likely user may be a cash-compensated employee. The cash transaction system comprises an automated cash receiving and storing machine and a remote database designed to communicate with the automated cash receiving and storing machine via Internet. The automated cash receiving and storing machine includes an outer housing, a computerized means adaptable to communicate with at least one remote device via the Internet, a user-interface touch screen panel, a cash-verifying means designed to communicate with the computerized means and a receipt generating means for generating the receipt of a cash transaction. The cash transaction system utilizes a software means programmed on the computerized means to enable a user to deposit cash in the automated cash receiving and storing machine and to transfer at least one portion of the cash to at least one remote account without requiring a traditional bank account.

Other advantages of the present invention include:

Providing a system, device and method for performing a cash transaction using an automated cash receiving and storing machine;

Providing a compact, secure cash receiving and storing machine in the work-place of a user;

Providing a software means for enabling the user to participate in e-commerce and make payment to third parties using electronic funds transfers without requiring a traditional bank account; and

Providing a touch-screen interface to perform the cash transaction easily and efficiently.

Other advantages of the system, methods, and apparatus of the present invention include:

Providing a compact, secure cash-receiving apparatus in the work-place of cash-compensated employees;

Providing a means for promoting and selling various goods and services targeted at cash-compensated employees;

Providing a touch-screen interface to efficiently enable deposit and purchase transaction;

Providing software systems that electronically forward the deposited funds to the appropriate institution and account according the user's pre-determined or newly determined instructions;

Enabling direct deposits to IRA's, 401K retirement plans, checking or savings accounts, health plans, life insurance plans, college funds, branded mutual funds, vacation plans, or purchases directly to merchants;

Automatically distributing deposited-cash assets; and

Collecting the deposited funds from the apparatus.

One contemplated method according to one preferred embodiment of the present invention includes:

1. The POWR customer (user) enters his credentials (username and passcode) via the touch panel

2. The touch screen panel communicates through the network interface and makes a request to the website to validate the entered username and passcode

3. The website application queries the database and returns the customer's account information as stored in the database

4. The website application responds to the touch screen panel with the account information and the touch screen panel displays this account information for the user to select for deposit

5. The account is selected and the bill acceptor is enabled (the bill acceptor remains in a disabled state until a valid account has been selected)

6. The POWR customer inserts bills into the bill acceptor; the dollar amount of the inserted bills is stored in the registry and displayed on the touch screen

7. The POWR customer has an option to deposit money to another valid account, exit the application or, print a receipt

a. Deposit to another account: return to step 4

b. Exist the application: return to step 1 for next customer

c. Print a receipt: the CPU sends the account information and deposit amount to the thermal printer and activates the print command

8. The POWR customer's account information and the dollar deposited are returned to the website application via an HTML post and the entire transaction is inserted into the database.

Once a POWR account has been created, along with at least one valid financial institution account, the new customer is able to use any POWR machine at any location.

In a preferred embodiment, the system includes a website. The website (for example, www.poiontofwealthregister.com) is a Microsoft.net site written in C# via Visual Studio 2008. The website is designed using 3-tier architecture comprised of the font-end, middle-tier (business level) and database.

The POWR customer's (user) account information is stored in the SQL Server 2008 database using encryption on all sensitive data; account numbers, PINs, passwords.

An additional component of the present invention includes a system comprising, in part, communication with a remote, outside, financial institution. Accordingly, on an agreed upon schedule with the financial institution (FID), an automated process derived from POWR's website application pushes a nightly file to the FID (have to work with FID to obtain an agreed upon format—i.e. an XML file or a comma delimited flat file that is SFTP'd (secure FTP)) on a determined schedule.

### DESCRIPTION OF THE DRAWING

FIG. 1 is a schematic representation of a cash transaction system of the present invention.

FIG. 2 is a perspective view of an automated cash receiving and storing machine of the present invention.

FIG. 3 is a tabular representation of a first variable chart for a database and a software routine according to a preferred embodiment of the present invention.

FIG. 4 is a tabular representation of a second variable chart for a database and a software routine according to a preferred embodiment of the present invention.

FIG. 5 is a diagrammatic representation of a configuration card for a cash verifying means of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

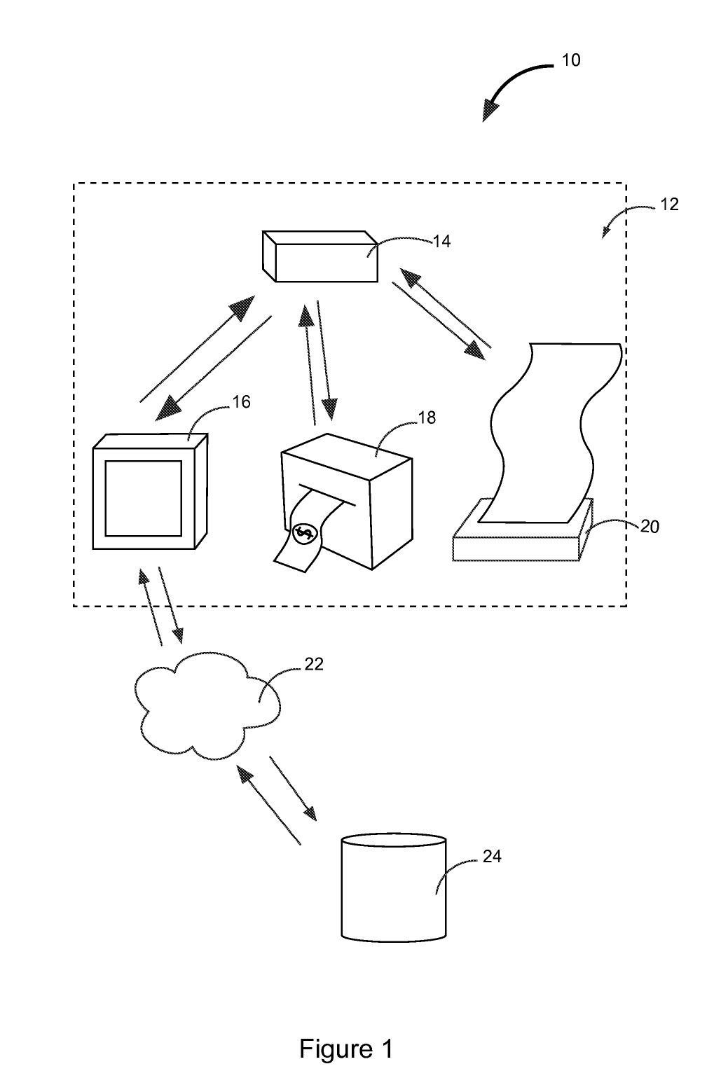

Referring to FIG. 1, a schematic representation of a cash transaction system 10 is illustrated. The cash transaction system 10 comprises an automated cash receiving and storing machine 12 and a remote database 24 designed to communicate with the automated cash receiving and processing machine 12 via Internet 22. The automated cash receiving and storing machine 12 includes an outer housing (not shown), a computerized means 14 adaptable to communicate with at least one remote device (not shown) via the Internet 22, a user-interface touch screen panel 16, a cash-verifying means 18 designed to communicate with the computerized means 14 and a receipt generating means 20 for generating the receipt of a cash transaction. The cash transaction system 10 utilizes a software means programmed on the computerized means 14 to enable a user to deposit cash in the automated cash receiving and storing machine 12 and to transfer at least one portion of the cash to at least one remote account without requiring a traditional bank account.

In the preferred embodiment of the present invention, the computerized means 14 is operable to store data, control at least one output to the user-interface touch screen panel 16, receive at least one input from the user-interface touch screen panel 16 and signal the receipt generating means 20. The computerized means 14 may be a programmable logic controller (PLC). The computerized means 14 is designed to communicate with the user-interface touch screen panel 16, the cash-verifying means 18 and the receipt generating means 20 in a bi-directional manner. The receipt generating means 20 includes a dispensing roll apparatus (not shown) for dispensing the receipt of the cash transaction and a print-head means (not shown) for printing information on the receipt. The receipt generating means 20 may be a thermal printer.

The remote database 24 includes a storage means adaptable to store a plurality of user information such as account information, balance of deposits, user identification details, user passwords and user preferences. The remote database 24 communicates with at least one remote processor (not shown) adaptable to communicate with a plurality of third party account systems. The software means programmed on the computerized means 14 is used to create a website. The user creates a user-account by registering in the website to deposit cash in the automated cash receiving and storing machine 12. The system 10 enables a real-time determination of the cash deposited in the at least one remote account.

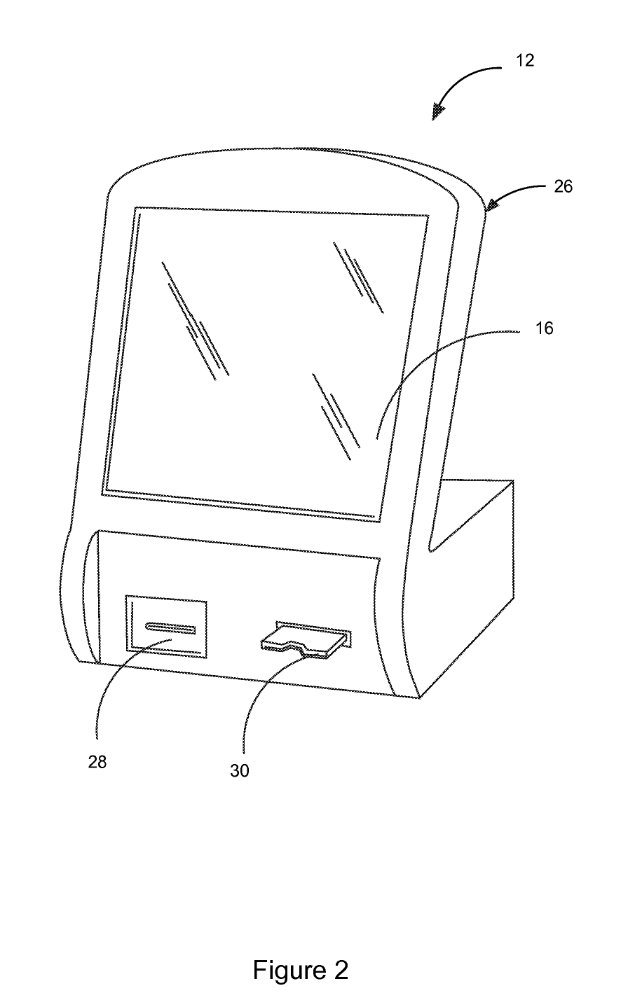

FIG. 2 illustrates a perspective view of the automated cash receiving and storing machine 12. The outer housing 26 of the cash receiving and storing machine 12 includes an input port 28 for receiving cash, an output port 30 for dispensing the receipt of the cash transaction and the user-interface touch screen panel 16. The cash receiving and storing machine 12 further includes a cash-store receptacle (not shown) for receiving cash from the input port 28 of the outer housing 26. The cash-verifying means 18 is positioned intermediate to the input port 28 and the cash store receptacle (not shown) of the cash receiving and storing machine 12. The cash-verifying means 18 may be a bill acceptor.

The preferred embodiment includes a method for performing the cash transaction using the cash transaction system 10. In the method, an employer having the traditional bank account creates a contract with the website. The user creates the user-account by registering in the website to deposit cash in the automated cash receiving and storing machine 12. The user can be a cash-compensated employee. The employer pays cash to the user and the user logs onto the website to deposit cash by entering login credentials of the user through the user-interface touch screen panel 16. The login credentials include a username and a password. The entered login credentials are verified with the remote database 24 for validation. Upon validation, the user-account information stored in the remote database 24 is displayed in the user-interface touch screen panel 16.

The user selects at least one employer's account through the user-interface touch screen panel 16 and the cash-verifying means 18 gets enabled. The user inserts at least one portion of the cash in the cash-verifying means 18. The cash-verifying means 18 verifies the inserted cash and the user deposits the cash to the at least one employer's account. Thus the at least one employer's account is credited with the deposited cash. The user-account is updated with the remaining cash after deposition. The website interacts with the user through the touch screen panel 16 to perform at least one financial transaction. The at least one financial transaction may be purchasing items from web based merchants, making a cash deposit to various plans like retirement plans, health plans, life insurance plans and vacation plans, contributing to college funds, depositing to branded mutual funds and savings accounts, and directing to another remote account. The website provides a plurality of electronic instructions to the user to pay for the at least one financial transaction using the cash deposited in the at least one employer's account. Upon performing the at least one financial transaction, the cash deposited in the at least one employer's account is distributed to at least one third party associated with the at least one financial transaction selected by the user and the user is made as payee of the at least one financial transaction. The remote database 24 is updated with information relating to the entire cash transaction done by the user. The receipt generating means 20 generates a receipt of the cash transaction. The user is provided with an option to deposit cash to another at least one remote account and to exit from the cash transaction.

The cash deposited in the automated cash receiving and storing machine 12 is virtually credited to the user, but the at least one financial transaction is manipulated from the at least one employer's account and thus the true debits and credits are funneled through the at least one employer's account. The cash deposited by the user in the machine 12 is collected by the employer and therefore there is no issue of cash robbery.

In an another embodiment of the present invention, the system 10 includes a computer such as a PC-Host brand having a MainBoard with an Asus P5K, a CPU such as LGA 775 and a Support CPU Intel Core 2 Duo E7200, Kingston DDRII800 2 GB RAM, a 160 GB S-ATA Hard Disk, RS-232 Ports; 8 USB Ports, a 10/100M Net Port; a LTP Net Card, a Sound Card, an Integrated Graphics Card, a Computer case and 350 W power supply. The system 10 further includes a monitor such as a 15″ TFT LCD with a brightness of 260 cd/m2, a contrast of 450:1, a response time of 16 ms, dot pitch of 0.297 and maximum resolution of 1024×768. Additionally, the system 10 includes a touch screen such as a 15″ SAW with High Transparence, high precision and durability antirust, anti-acid, and anti-dust features, a thickness of 6 mm, a Max: 4096×4096, a Surface Hardness: Mohs' hardness rating of 7 Force<100G, and a Response Time of 16 ms. Moreover, the system 10 includes a thermal printer such as a Custom TG2460 using 60 mm (width) thermal paper and having anti-paper-am, and static electricity dissipating features, a print speed of 200 dpi and an automatic paper cutter, paper running-out alarm, paper run-out alarm, and black mark sensor.

The aforementioned system 10 further includes a bill accepter model BV-100 with capabilities and features including: a Stacker up or down stacking with stacker capacity of 300 or 500 notes (higher capacity on request), a lockable stacker, a power supply 12VDC +/−10%. Further, the system 10 accepts notes in just three seconds and possesses simple and advanced programming tools via configuration card. Additionally, the system 10 has a PC or handheld unit innovation in a standard space envelope and able to perform the transactions quickly with high acceptance rate of typically 99.8% using SPF™ technology. Moreover, the system 10 is designed for easy installation and simple maintenance and has modular interface (flexible connectivity) USB on-board.

The power supply of the system 10 comprises an AC 110V-240V, DC 24v 5 A, 5v 3 A. The system 10 further includes a speaker with left and right channels and a standard KMY-8700 enclosure having a durable steel frame, powder coated steel back covers. The enclosure is easy to install and operate, moisture-proof and has anti-rust, anti-acid, and anti-dust characteristics, and is static free. Further, the enclosure includes four fans for aeration and down temperature, and a power supply inside. The system 10 uses an operating system with specification—Microsoft Windows XP+SP2 (Test version, English language).

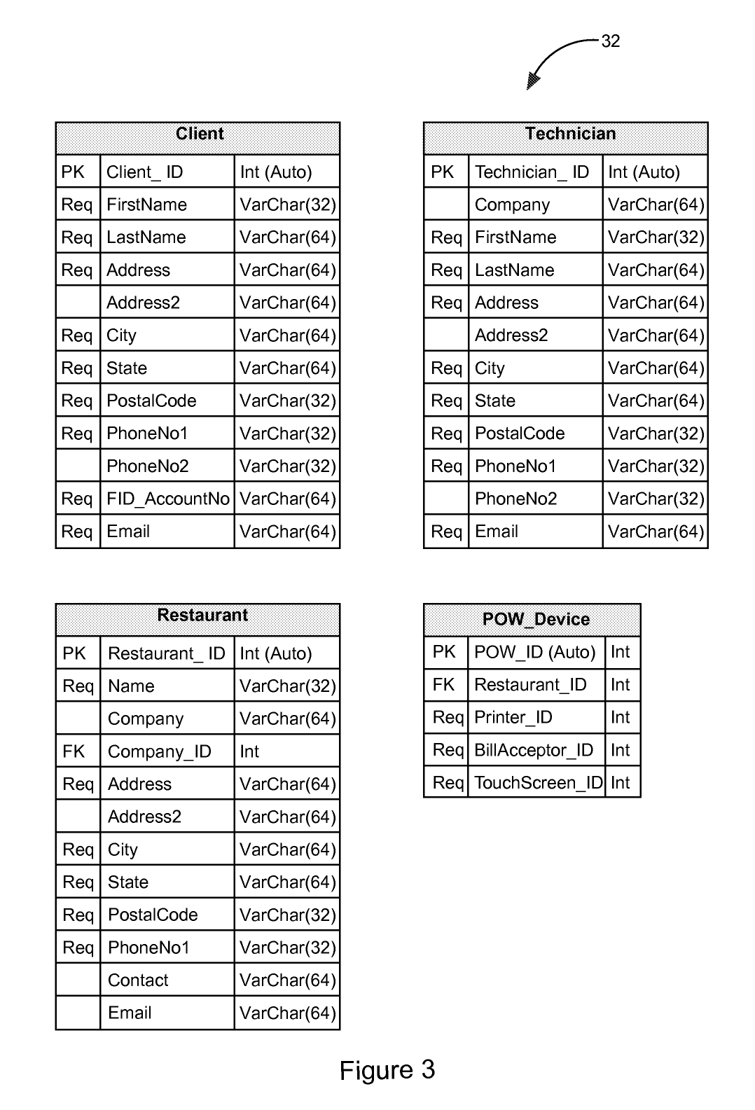

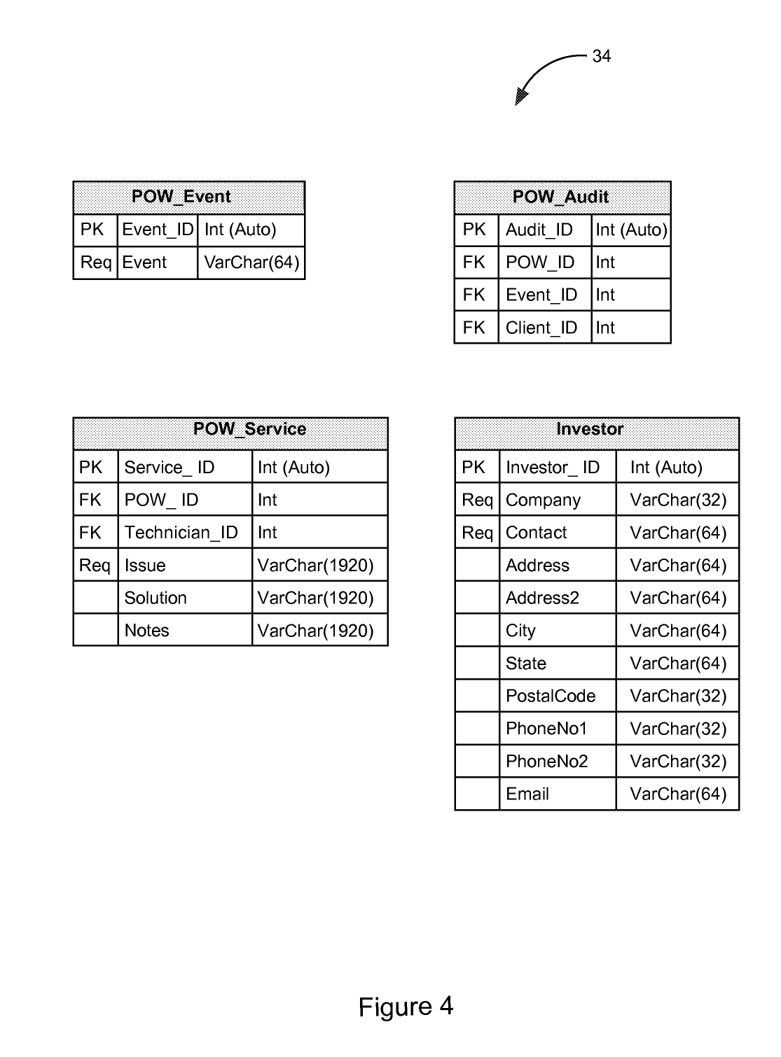

FIG. 3 is a tabular representation of a first variable chart for a database and a software routine 32 and FIG. 4 is a tabular representation of a second variable chart for a database and a software routine 34 according to a preferred embodiment of the present invention.

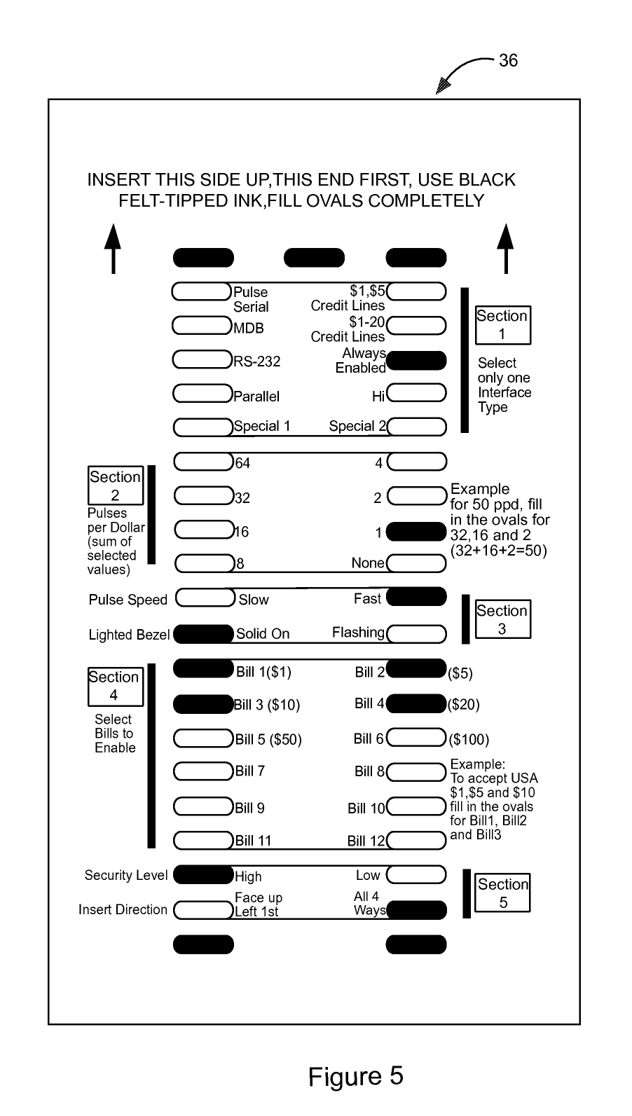

FIG. 5 is a diagrammatic representation of a configuration card 36 for the cash verifying means 18 of the present invention.

The method of the present invention includes providing access to an individual retirement account through a third-party provider. In contrast to existing transactions, which require an employer to sponsor employees in an IRA program, and further IRA accounts require minimum deposits per transaction, typically, in increments of $25 or, more commonly, $100, many cash-compensated employees have been unable to participate in IRA programs. According, the method of the present invention enables cash-compensated employees to deposit cash into the machine and designate fractional dollars to an IRA program.

Although the invention has been particularly shown and described with reference to certain embodiments, it will be understood by those skilled in the art that various changes in form and detail may be made without departing from the spirit and scope of the invention.

We claim:

1. A cash transaction system comprising:
an automated cash receiving and storing machine, the automated cash receiving and storing machine comprising:
an outer housing having an input port for receiving cash, an output port for dispensing a receipt of a cash transaction and a user-interface touch screen panel;
a computerized means adaptable to communicate with at least one remote device via Internet;
a cash-store receptacle for receiving the cash from the input port of the outer housing;
a cash-verifying means positioned intermediate to the input port and the cash-store receptacle, the cash-verifying means being designed to communicate with the computerized means; and
a receipt generating means for generating the receipt selectively dispensed out from the output port; and
a remote database designed to communicate with the automated cash receiving and storing machine via the Internet;
whereby the cash transaction system utilizes a software means programmed on the computerized means to enable a user to deposit cash in the automated cash receiving and storing machine and to transfer at least one portion of the cash to at least one remote account without requiring a traditional bank account.

2. The cash transaction system of claim 1 wherein:
the computerized means is operable to store data, receive at least one input from the user-interface touch screen panel, control at least one output to the user-interface touch screen panel and signal the receipt generating means.

3. The cash transaction system of claim 1 wherein:
the receipt generating means includes a dispensing roll apparatus for dispensing the receipt and a print-head means for printing information on the receipt.

4. The cash transaction system of claim 1 wherein:
the receipt generating means comprises a thermal printer.

5. The cash transaction system of claim 1 wherein:
the cash-verifying means comprises a bill acceptor.

6. The cash transaction system of claim 1 wherein:
the remote database includes at least one storage means adaptable to store a plurality of user information.

7. The cash transaction system of claim 1 wherein:
the plurality of user information stored in the remote database includes account information, balance of deposits, user identification details, user passwords and user preferences.

8. The cash transaction system of claim 1 wherein:
the remote database communicates with at least one remote processor adapted to communicate with a plurality of third party account systems.

9. The cash transaction system of claim 1 wherein:
the system enables real-time determination of the cash deposited in the at least one remote account.

10. An automated cash receiving and storing machine comprising:
an outer housing having an input port for receiving cash, an output port for dispensing a receipt of a cash transaction and a user-interface touch screen panel;
a computerized means adaptable to communicate with at least one remote device via Internet;
a cash-store receptacle for receiving the cash from the input port of the outer housing;
a cash-verifying means positioned intermediate to the input port and the cash-store receptacle, the cash-verifying means being designed to communicate with the computerized means; and
a receipt generating means for generating the receipt selectively dispensed out from the output port;
whereby the automated cash receiving and storing machine utilizes a software means programmed on the computerized means to enable a user to deposit cash in the automated cash receiving and storing machine and to transfer at least one portion of the cash to at least one remote account without requiring a traditional bank account.

11. The automated cash receiving and storing machine of claim 10 wherein:
the receipt generating means comprises a thermal printer.

12. The automated cash receiving and storing machine of claim 10 wherein:
the cash-verifying means comprises a bill acceptor.

13. The automated cash receiving and storing machine of claim 10 wherein:
the computerized means is operable to store data, receive at least one input from the user-interface touch screen panel, control at least one output to the user-interface touch screen panel and signal the receipt generating means.

14. The automated cash receiving and storing machine of claim 10 wherein:
the receipt generating means includes a dispensing roll apparatus for dispensing the receipt and a print-head means for printing information on the receipt.

15. A method for performing a cash transaction using an automated cash receiving and storing machine, the method comprising:
(a) providing the automated cash receiving and storing machine;
(b) creating a contract with a website by an employer having a traditional bank account;
(c) creating a user-account in the website by a user;
(d) receiving cash from the user;
(e) entering login credentials by the user through a user-interface touch screen panel on the automated cash receiving and storing machine to log onto the website;
(f) verifying the login credentials of the user with a remote database;
(g) validating the login credentials and displaying the user-account information stored in the remote database;
(h) selecting at least one employer's account by the user and enabling a cash-verifying means in the automated cash receiving and storing machine;
(i) inserting at least one portion of the cash in the cash-verifying means;
(j) verifying the at least one portion of the cash by the cash-verifying means and depositing the cash to the at least one employer's account by the user;
(k) updating the user-account with the cash amount on hand;
(l) interacting with the user by the website to perform at least one financial transaction;
(m) providing a plurality of electronic instructions to the user by the website to pay for the at least one financial transaction using the cash deposited in the at least one employer's account;
(n) distributing the cash deposited in the at least one employer's account to at least one third party associated with the at least one financial transaction selected by the user and making the user as payee of the at least one financial transaction; and
(o) updating the remote database with information relating to the cash transaction.

16. The method of claim 15 further comprising:
(p) sending an electronic mail receipt detailing the transactions to a user's designated electronic mail account.

17. The method of claim 15 further comprising:
providing the automated cash receiving and storing machine having a receipt generating means to generate a receipt of the cash transaction performed by the user.

18. The method of claim 15 further comprising:
enabling the user to deposit cash in the automated cash receiving and storing machine without requiring a traditional bank account.

19. The method of claim 15 further comprising:
enabling the user to selectively allocate cash to an individual retirement account.
